(19) United States
(12) Patent Application Publication
(10) Pub. No.: US 2011/0162503 A1
(43) Pub. Date: Jul. 7, 2011

(54) APPARATUS TO FORM PERFORATIONS

(75) Inventors: Osamu Ishikawa, Kagawa (JP); Yoshitaka Mishima, Kagawa (JP)

(73) Assignee: UNI-CHARM CORPORATION, Ehime (JP)

(21) Appl. No.: 13/063,704

(22) PCT Filed: Jul. 17, 2009
(86) PCT No.: PCT/JP2009/063002

§ 371 Date: Mar. 11, 2011

(30) Foreign Application Priority Data
Sep. 16, 2008 (JP) 2008-237147

(51) Int. Cl. B26F 1/24

(52) U.S. Cl. 83/660

(57) ABSTRACT

An apparatus of making perforations along which a package can be smoothly ripped includes a housing and a driving mechanism. Below a top wall of the housing, a top plate operatively is coupled to the driving mechanism. A blade assembly holding plate is attached to the bottom side of the top plate. Below the perforating blade assembly holding plate, there is provided a pressure plate including a base layer and a rubber layer, so that the blade holding plate is interposed between the pressure plate and the top plate. The pressure plate is formed with a slit extending therethrough in its thickness direction. Below the pressure plate, a loading plate is formed with a slit extending therethrough in its thickness direction and on which a film sheet can be loaded. Below the loading plate, a base plate is fixed to a bottom wall of the housing.

### CROSS REFERENCE TO RELATED APPLICATIONS

The present application is national phase of International Application Number PCT/JP2009/063002 filed Jul. 17, 2009, and claims priority from, Japanese Application Number 2008-237147, filed Sep. 16, 2008.

### TECHNICAL FIELD

The present invention relates to an apparatus to form perforations to rip a package of sanitary articles and particularly to an apparatus to form a package adapted to pack a plurality of sanitary articles, for example, disposable diapers with perforations along which the package may be smoothly ripped to take the diaper out from the package.

### RELATED ART

Conventionally, packages adapted to pack a plurality of disposable diapers such as sanitary articles therein in a face-to-face fashion is known. For example, in PATENT DOCUMENT 1, a package is made of a relative soft material such as polyethylene therein a plurality of disposable diapers compressed together. The package is previously formed with perforations along which the package may be ripped to take the diaper out from the package.
[PATENT DOCUMENT 1] JP 2006-290383 A

### DISCLOSURE OF THE INVENTION

### Problem to be Solved by the Invention

In the case of this known example, the perforations for the package are formed by pressing a perforating blade assembly against a polyethylene film placed on an elastic plate until individual perforating blades run through the film and partially stick into an elastic plate. However, the film also bites into the elastic plate as the perforating blade assembly is pressed against the elastic plate, making it difficult for the individual blades to run through the film. If it is difficult for the individual blades to run through the film, a length of each slid defining each perforation might be unacceptably short or even some or all of the expected perforations might not be formed. With such defective perforations, the package can not be smoothly ripped. Furthermore, for every cycle of forming the perforations, the individual perforating blades partially stick into the elastic plate and, in consequence, the blades may be damaged at a high frequency. A frequency at which the blades should be exchanged with fresh ones becomes and a production cost for the blades correspondingly increases.

In view of the problem left by the prior art unsolved behind as has been described above, it is an object of the present invention to provide an improved apparatus to form the perforations along which packages can be smoothly ripped, on one hand, and leading to a cost saving for production of the packages.

### Measure to Solve the Problem

The object set forth above is achieved, according to the present invention, by an improvement in an apparatus to form perforations comprising a loading plate on which a film sheet can be loaded, a perforating blade assembly adapted to form the film sheet with the perforations and a driving mechanism serving to move the perforating blade assembly up and down in a vertical direction so as to cut through the film sheet. The term “perforations” used herein refers to a series of sheet slits or small holes formed by cutting through the sheet so that the sheet may be continuously ripped along such short slits or small holes.

The improvement according to the present invention is characterized in that the apparatus further comprises a pressure plate opposed to the loading plate and adapted to press the film sheet against the loading plate, the loading plate has a slit formed through the loading plate adapted to be engaged with the perforating blade assembly, and the pressure plate is provided on its surface opposed to the film sheet with an anti-slip means.

According to one preferred embodiment, the perforating blade assembly is held by a blade holding plate, a biasing means is provided between the blade holding plate and the pressure plate to bias these blade holding plate and the pressure plate in the vertical direction, and the holding plate is adapted to move the perforating blade assembly into the slit formed through the loading plate against a biasing effect of the biasing means.

According to another preferred embodiment, the surface of the loading plate opposed to the film sheet is elastic at least in the vertical direction.

According to still another preferred embodiment, the loading plate itself is provided on its surface opposed to the film sheet with an anti-slip means.

According to yet another preferred embodiment, the perforating blade assembly comprises a plurality of individual blades arranged in a line and each of the individual blades comprises a pointed tip facing the film sheet, a pair of oblique edges obliquely extending from the pointed tip in the vertical direction and a transverse direction orthogonal to the vertical direction wherein the oblique edges gradually draw apart one another in the transverse direction as they come upward in the vertical direction and a pair of parallel lateral edges extending upward from respective upper ends of the oblique edges in the vertical direction.

According to further another preferred embodiment, at least a range of the individual blade extending from the pointed tip to the parallel lateral edges is movable into the slit formed through the loading plate.

According to an alternative preferred embodiment, the pressure plate has a slit formed through said pressure plate in its thickness direction and having a substantially same shape as the slit formed through the loading plate, and the individual blades are adapted to pass through the slit formed through the pressure plate and then to be engaged with the slit formed through the loading plate.

According to another preferred embodiment, two or more layers of the film sheet are put flat together in a thickness direction thereof and loaded on the loading plate.

### Effect of the Invention

The film sheet loaded on the loading plate may be pressed by the anti-slip means as a part of the pressure plate against the loading plate and simultaneously cut through by the perforating blade assembly to form the perforations to restrict the film sheet from being curled into the loading plate. As a consequence, it is possible to form the film sheet with the perforations, each having the predetermined length, along which the package can be smoothly ripped. The loading plate is formed with the slit adapted to be engaged with the perforating blade assembly so that the film sheet may be formed with the perforations as the perforating blade assembly moves into this slit. The individual blades would not move downward beyond the depth of the slit of the loading plate and stick the base plate. In other words, it is possible to protect the individual blades from being damaged due to sticking the loading plate, thus to reduce a frequency at which the perforating blade assemble must be exchanged with fresh blade assembly and thereby to reduce the production cost.

### BRIEF DESCRIPTION OF THE DRAWINGS

FIG. 1 is a perspective view of a package.

FIG. 2 is a plan view of the package.

FIG. 3 is a perspective view of an apparatus to form perforations.

FIG. 4 is a front view of the apparatus.

FIG. 5 is a perspective view of a perforating blade assembly.

FIG. 6 is a diagram illustrating the individual perforating blades in an enlarged scale.

FIG. 7 is a plan view of a pressure plate.

FIG. 8 is a plan view of a loading plate.

FIG. 9 is a scale-enlarged view of an encircled region IX in FIG. 4.

FIG. 10 is a diagram illustrating how the apparatus operates.

FIG. 11 is a diagram illustrating how the apparatus operates.

### IDENTIFICATION OF REFERENCE NUMERALS USED IN THE DRAWINGS

1 package
11 perforations
14 film sheet
20 apparatus
40 driving mechanism
50 top plate
60 blade holding plate
70 perforating blades
73 individual blades
74 pointed tip
75 oblique edges
76 parallel lateral edges
80 pressure plate
82 rubber layer (anti-slip means)
87 pressure plate's slit
90 biasing means
100 loading plate
105 loading plate's slit

### DETAILED DESCRIPTION OF THE PREFERRED EMBODIMENTS

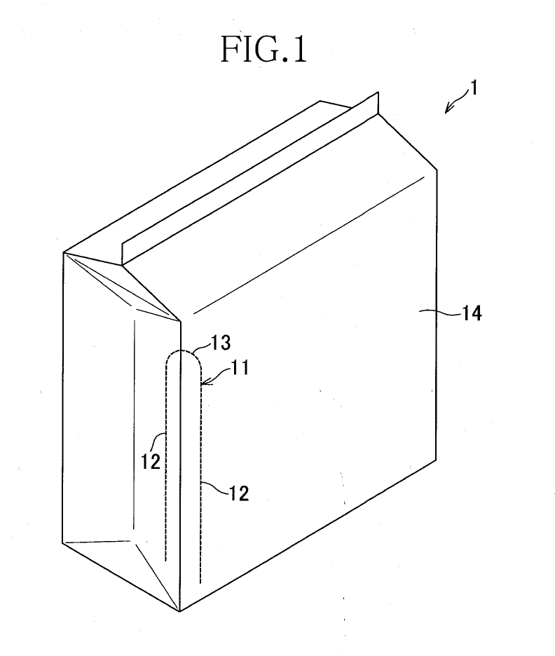

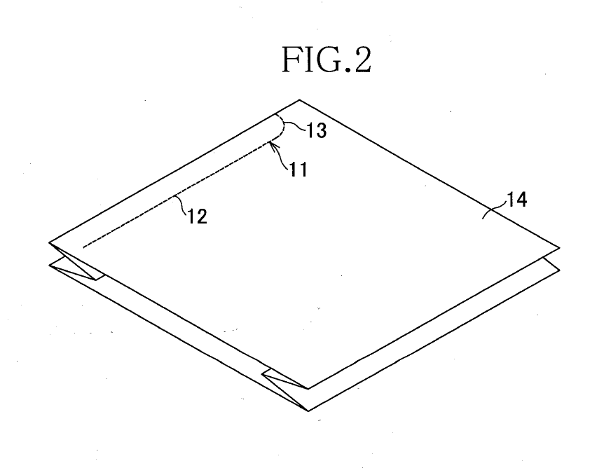

FIG. 1 is a perspective view of a package 1 containing therein a plurality of disposable diapers and FIG. 2 is a plan view of the package 1 in a collapsed state before the diapers are packed. The package 1 is shaped in generally rectangular parallelepiped and is formed in the vicinity of one of its four corners with perforations 11 along which the package 1 is ripped so that the individual diapers contained therein are smoothly taken out one by one. The package 1 is formed of a film sheet 14 made of, for example, low density polyethylene (LDPE) having flexibility. The package 1 is formed with the perforations 11 in a collapsed state. As illustrated, the film sheet 14 is initially annular and diametrically opposite segments thereof are folded inward, i.e., gusseted. One of these gusseted segments each comprising four layers is formed with the perforations 11. After the package 1 of such film sheet 14 has been formed with the perforations 11, the package 1 may be opened from its collapsed state and filled with a plurality of disposable diapers to expose the perforations 11 comprising a pair of first segments 12 vertically extending symmetrically about one of four vertical edge lines and a second segment 13 connecting these two first segments with each other.

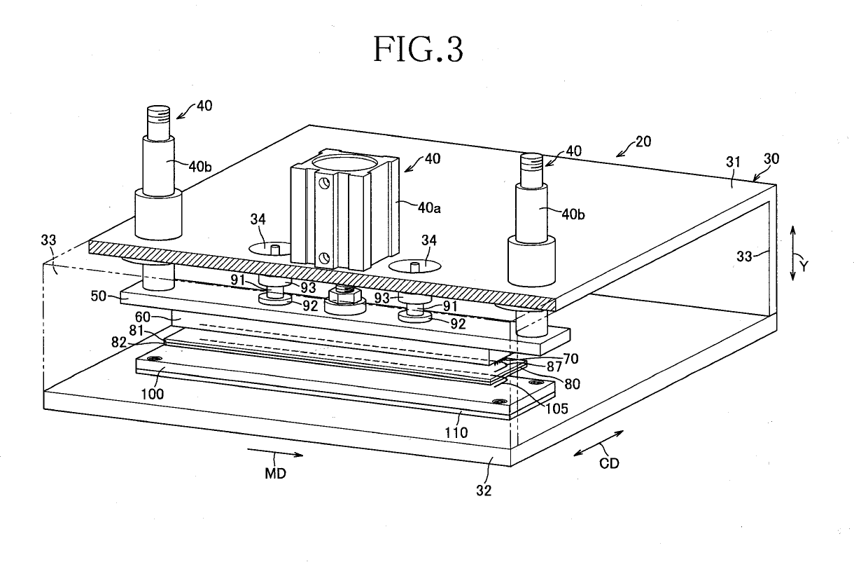

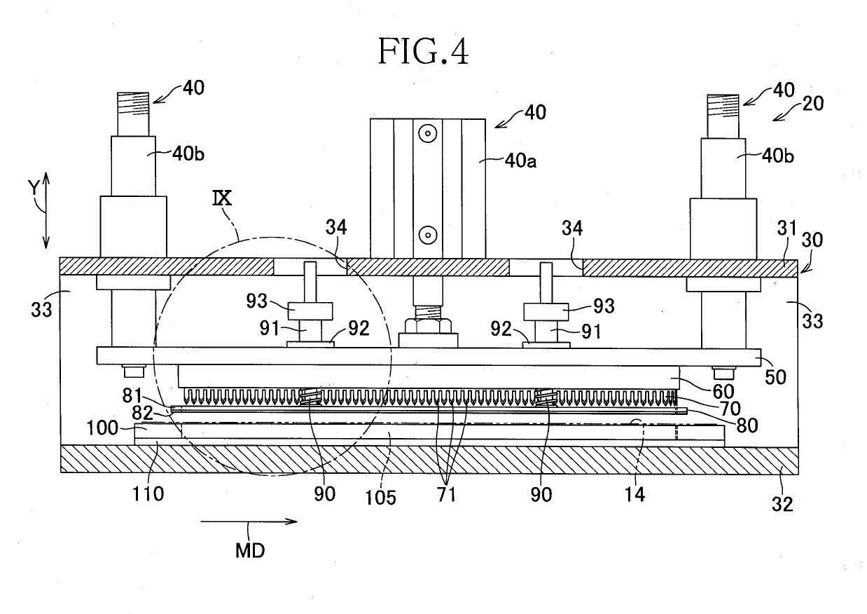

One embodiment of the apparatus to form the perforations 11 in the package, will be described. FIG. 3 is a perspective view showing an apparatus 20 to form the perforations as partially broken away for convenience of illustration. FIG. 4 is a side view of the apparatus 20 of FIG. 3 as viewed in a cross direction CD. The apparatus 20 has a vertical direction Y and a transverse direction orthogonal to the this direction Y wherein the term “transverse direction” used herein should be construed to be defined by a machine direction MD in which the film sheet 14 as the material for the package 1 is fed and the cross direction CD orthogonal to the machine direction MD. The vertical direction Y is a direction extending through the film sheet 14 being fed in its thickness direction.

The apparatus 20 comprises a housing 30, a plurality of plates contained within the housing 30 and a driving mechanism 40 provided outside the housing 30 to move some of the plates up and down. The housing 30 has a top wall 31, a bottom wall 32 both as viewed in the vertical direction Y and two side walls 33 opposed to each other in the cross direction CD. Below the top wall 31 of the housing 30, i.e., within the housing 30, there is provided a top plate 50 operatively associated with the driving mechanism 40 so as to be moved up and down in the vertical direction. The driving mechanism 40 comprises a hydraulic control mechanism 40a and a pair of slidable guide support 40b. Although details of the driving mechanism 40 are not illustrated, this mechanism 40 is known to those skilled in the art. Below the top plate 50 as viewed in the vertical direction Y, there is provided a holding plate 60 for a perforating blade assembly 70. The blade assembly holding plate 60 is fixed to the top plate 50 so as to be operatively associated with the top plate 50 and to move up and down.

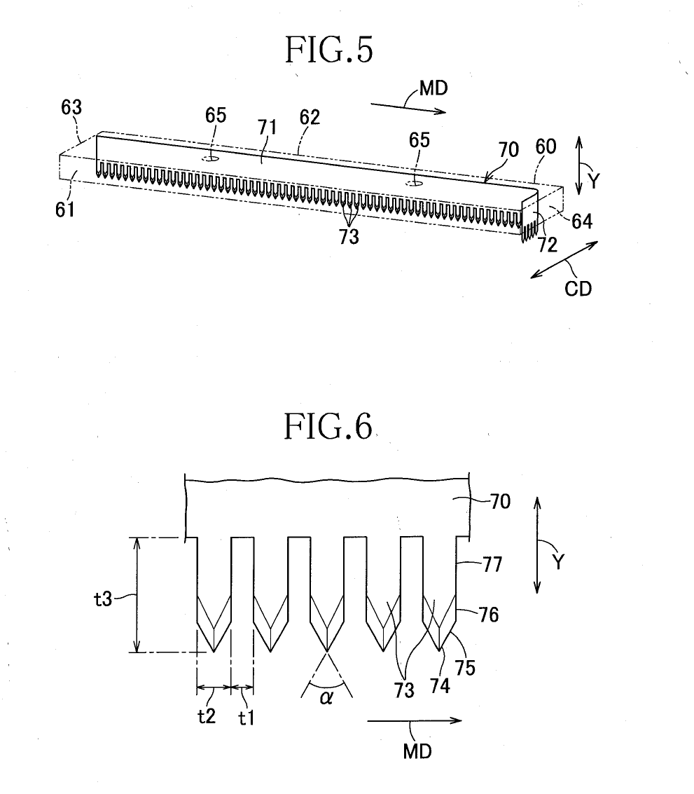

FIG. 5 is a perspective view of the perforating blade assembly 70 wherein the blade assembly holding plate 60 is indicated by an imaginary line. FIG. 6 is a diagram illustrating a part of FIG. 5 in an enlarged scale. The blade assembly holding plate 60 includes opposite side walls 61, 62 extending in the machine direction MD and front and rear end walls 63, 64 extending in the cross direction CD. Under the blade assembly holding plate 60 in the vertical direction Y, the perforating blade assembly 70 is provided. The perforating blade assembly 70 has a first segment 71 extending from the front end 63 toward the rear end 64 and a second segment 72 curving at the vicinity of the rear end 64 of the first segment 71 so as to extend in the cross direction CD. In this manner, the perforating blade assembly 70 has a generally L-shaped. The first segment 71 adapted to form a first segments 12 of the perforations and the second segment 72 is adapted to form the second segment 13 of the perforations 11 (See FIGS. 1 and 2).

The perforating blade assembly 70 comprises a plurality of individual blades 73 each extending in the vertical direction Y. Each of these individual blades 73 has, as viewed in the vertical direction Y from the bottom, a pointed tip 74, opposite oblique edges 75 extending upward obliquely from the pointed tip 74 so as to be gradually drawn apart from each other in the machine direction MD and opposite parallel edges 76 extending upward in parallel to each other from respective ends of the oblique edges 75 in the vertical direction Y. The individual blade 73 has its thickness gradually thinned toward its periphery to form a sharp blade adapted to cleave the film sheet 14 and thereby to shape an individual slit. The parallel lateral edges extend further upward in the vertical direction to define a basal portion 77 adapted to be held by the blade assembly holding plate 60. The respective basal portions 77 have no sharp edge which would cleave the film sheet 14.

The oblique edges 75 of the individual blade are drawn apart from each other around the associated pointed tip 74 at an angle α of about 60° so as to define part of an isosceles triangle. In this embodiment, a dimension t1 by which each of the blades 73 is spaced from the adjacent blade 73 as measured between the parallel lateral edges 76 of these adjacent blades 73 directly opposed to each other is about 1.5 mm, a width dimension t2 of the blade 73 as measured in the machine direction MD is about 3 mm, and a thickness dimension of the blade 73 as measured in the cross direction CD is about 0.7 mm. A length dimension t3 of the blade 73 as measured from the upper end of the basal portion 77 to the pointed tip 74 in the vertical direction Y is about 10 mm. It should be appreciated here that the dimension t1 specified above is with respect to the first segment 71 and the dimension t1 with respect to the second segment 72 is about 2 mm. It should be also appreciated that, with respect to the second segment 72, the thickness dimension of the blade 73 is given as measured in the machine direction MD. The other dimensions are common to these two segments 71, 72.

Below the blade assembly holding plate 60 in the vertical direction Y, there is provided a pressure plate 80 comprising a base layer 81 as an upper component as viewed in the vertical direction Y and a rubber layer 82 as a lower component as viewed in the vertical direction Y. The base layer 81 may be made of suitable metallic materials such as stainless steels and the rubber layer 82 may be made of silicon rubbers. The rubber layer 82 serves as anti-slip means for the film sheet 14. Such pressure plate 80 is attached to the top plate 50 by the intermediary of a pair of shafts 91, 91. The blade assembly holder plate 60 is interposed between the pressure plate 80 and the top plate 50 and formed with shaft-holes through which the respective shafts 91, 91 are slidably moved. Between the top plate 50 and the pressure plate 80, there are provided biasing means 90 serving to bias these plates 50, 80 in the vertical direction Y. The biasing means 90 may be implemented in the form of a coil spring mounted around the shafts 91, 91, respectively.

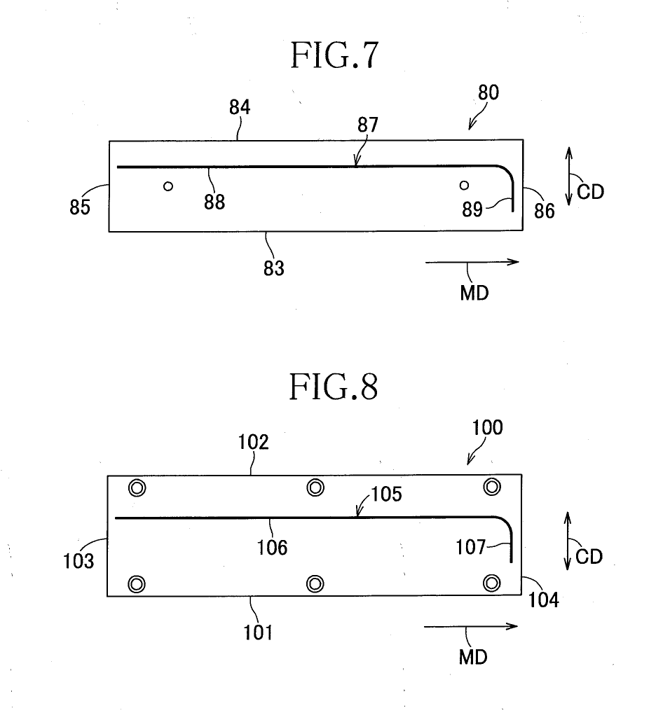

FIG. 7 is a plan view of the pressure plate 80 having side edges 83, 84 extending in the machine direction MD and front and rear ends 85, 86 extending in the cross direction CD. The pressure plate 80 is formed with a slit 87 extending through the pressure plate 80 in the thickness direction, i.e., in the vertical direction Y. This slit 87 has a shape substantially the same as the shape of the perforating blade assembly 70 so that the individual blades may collectively pass through this slit 87. Specifically, the slit 87 formed through the pressure plate 80 comprises a first segment 88 extending in the machine direction MD from the front end 85 toward the rear end 86 and a second segment 89 extending in the cross direction CD from the vicinity of the rear end 86 of the first segment 88 toward the side edge 83 so that the first segment 88 cooperates with the second segment 89 to describe a generally L-like shape. A width dimension of this slit 87 formed through the pressure plate 80 is larger than the thickness dimension of the individual blades 73. Such relative dimension allows the perforating blade assembly 70 to pass through the slit 87 of the pressure plate 80.

Below the pressure plate 80 as viewed in the vertical direction Y, there is provided a loading plate 100 on which the film sheet 14 can be loaded. FIG. 8 is a plan view of the loading plate 100. The loading plate 100 has side edges 101, 102 extending in the machine direction MD and front and rear ends 103, 104 extending in the cross direction CD. The loading plate 100 is formed with a slit 105 extending through the loading plate 100 in the thickness direction, i.e., in the vertical direction Y. This slit 105 has a shape substantially the same as the shape of the perforating blade assembly 70 as well as of the slit 87 formed through the pressure plate 80. Specifically, the slit 105 formed through the loading plate 100 comprises a first segment 106 extending in the machine direction MD from the front end 103 toward the rear end 104 and a second segment 107 extending from the vicinity of the rear end 104 of the first segment 106 in the cross direction CD so as to describe a curve so that the first segment 106 cooperates with the second segment 107 to describe a generally L-like shape. The loading plate 100 is made of urethane having hardness Hs of 90, elasticity at least in the vertical direction Y and serves as anti-slip means for the loading plate 100. Hardness of the loading plate 100 is measured in accordance with JIS Z 2246.

Below the loading plate 100 as viewed in the vertical direction Y, there is provided a base plate 110. The base plate 110 is formed with no slit and serves to close the slit 105 formed through the loading plate 100. The base plate 110 may be made of urethane similar to the material for the loading plate 100. However, it should be appreciated that the base plate 110 may be made of any kind of materials other than urethane so far as the slit formed through the loading plate 100 can be effectively closed. The base plate 110 has its bottom surface fixed to the bottom wall 32 of the housing 30. In this way, the loading plate 100 and the base plate 110 are integrally fixed to the housing 30.

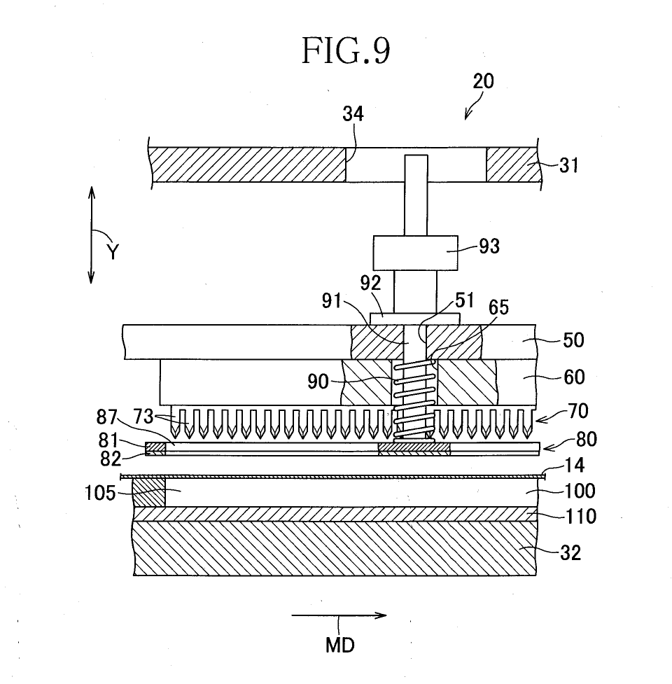

With the construction as has been described above, the apparatus 20 operates in the manner as will be described in reference to FIGS. 9 through 11. FIG. 9 shows the encircled region IX in FIG. 4 in an enlarged scale and partially in a sectional view. As will be understood from FIG. 9, the film sheet 14 is fed to the apparatus 20 and loaded on the loading plate 100. Thereupon, the driving mechanism (not shown) drives the top plate 50 and the blade assembly holding plate 60 to move downward in the vertical direction Y. The pressure plate 80 is coupled to the top plate 50 by the shaft 91. Specifically, the top plate 50 is provided on its upper surface as viewed in the vertical direction Y with a holder 92 adapted to stabilize an upper portion of the shaft 91 so that the shaft 91 would be slidably moved through the shaft-hole 51 formed through the top plate 50. The lower end of the shaft 91 is fixed to the pressure plate 80.

The shaft 91 extends through the shaft-hole 65 which has a diameter larger than that of the shaft-hole 51. Such differential diameter forms a step between these two shaft-holes 51, 65. The shaft-hole 65 formed through the blade assembly holding plate 60 is provided with the biasing means 90 having its upper end held in contact with the bottom surface of the top plate 50 and its lower end held in contact with the pressure plate 80 so as to bias both the top plate 50 and the pressure plate 80 in the vertical direction Y.

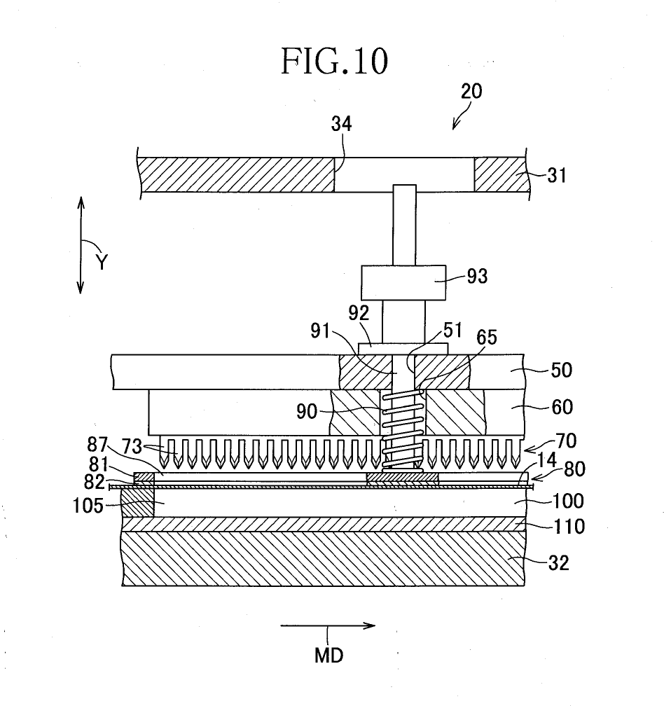

Movement of the top plate 50 downward in the vertical direction Y from the state as has been described above causes the pressure plate 80 also to be moved downward in the vertical direction Y by the operation of the shaft 91 as illustrated in FIG. 10. The pressure plate 80 includes the rubber layer 82 defining the lower surface of the pressure plate 80 and this rubber layer 82 comes in contact with the film sheet 14 loaded on the loading plate 100. In this way, the film sheet 14 is sandwiched between the rubber layer 82 of the pressure plate 80 and the loading plate 100.

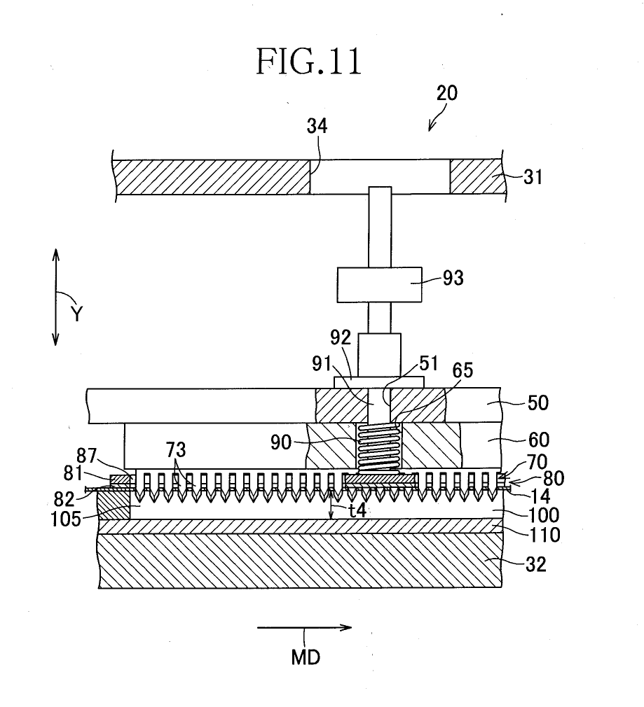

FIG. 11 illustrates a state after the top plate 50 has been further pressed down in the vertical direction Y from the state illustrated in FIG. 10. Specifically, the top plate 50 moves downward together with the blade assembly holding plate 60 with the biasing means 90 being forcibly bowed down in the vertical direction Y and the holder 92 being spaced from a stopper 93. As the biasing means 90 is forced by the bottom surface of the top plate 50 and the top surface of the base layer 81 constituting the pressure plate 80 to be bowed in the vertical direction Y, the perforating blade assembly 70 pass through the slit 87 of the pressure plate 80 into the slit 105 of the loading plate 100.

The perforating blade assembly 70, the slit 87 of the pressure plate 80 and the slit 105 of the loading plate 100 are formed so as to present substantially the same shape so that the perforating blade assembly 70 may pass through the slit 87 of the pressure plate 70 into the slit 105 of the loading plate 100 without coming in contact with both the pressure plate 80 and the loading plate 100. In this way, the film sheet 14 sandwiched between the pressure plate 80 and the loading plate 100 can be formed with the slits corresponding to the individual blades 73 and these slits define the desired perforations.

The pressure plate 80 is pressed down toward the loading plate 100 against a biasing force of the biasing means 90 and thereby the film sheet 14 interposed between the pressure plate 80 and the loading plate 100 is pressed against the loading plate 100 so as to be securely held between these pressure plate 80 and the loading plate 100. Particularly in the case of this embodiment wherein the film sheet 14 folded in a plurality of layers is to be formed with the perforations, these layers of the film sheet 14 which otherwise would be apt to slip with respect to one another can be held together by pressing against one another and thereby prevented from being displaced with one another due to relative slippage.

Even in the course of squeezing the film sheet 14 between the pressure plate 80 and the loading plate 100 so that the perforating blade assembly 70 moves downward in the vertical direction Y to cut through the film sheet 14, the film sheet 14 would not follow the movement of the perforating blade assembly 70. As a consequence, the perforating blade assembly 70 can reliably cut through the film sheet 14 and it is ensured that the slits each having a predetermined length corresponding to the width dimension of the individual blade can be formed on the film sheet 14. These slits each having the predetermined length assures that the film sheet 14 can be smoothly ripped along the perforations without an anxiety that any one or more of the perforations might make it difficult to rip the film sheet 14.

The length dimension t3 of the individual blade 73 is set to be larger than a sum of the dimension of the pressure plate 80 as measured in the vertical direction Y and the thickness dimension of the film sheet 14 as measured in the vertical direction Y but to be smaller than a sum of the thickness dimension of the pressure plate 80, the thickness dimension of the film sheet 14 and a depth dimension t4 as measured in the vertical direction Y from the slit 105 of the loading plate 100 to the base plate 110. Consequently, the individual blades 73 reliably cut through the film sheet 14 without a possibility that the individual blades 73 might move downward beyond the depth of the slit 105 of the loading plate 100 and stick the base plate 110. In other words, it is possible to protect the individual blades 73 from being damaged due to sticking the base plate 110, thus to reduce a frequency at which the individual blades 73 must be exchanged with fresh blades and thereby to reduce the production cost.

The film sheet 14 is held between the anti-slip means provided on the pressure plate 80 and the anti-slip means provided on the loading plate 100 to assure that the film sheet is further reliably prevented from being relatively displaced from one another and thus the perforations can be reliably formed.

The individual blade 73 is of a so-called double edged type having a pair of the oblique edges 75 opposed to each other in the machine direction MD so that the slit would be enlarged from the pointed tip 74 outward as the blade 73 cut through the film sheet 14. Compared to the blade of a so-called single edged type, the length dimension of the oblique edge can be shortened and thereby the parallel lateral edges can be smoothly moved down to the film sheet 14. The parallel lateral edges 76 of all the individual blades evenly move down to the film sheet 14 and it is assured thereby that the slits each having the predetermined length can be formed by the respective individual blades 73. More specifically, if one or more of the individual blades 73 have the respective oblique edges 75 can not fully cut through the film sheet 14, even a slight differential movement thereof in the vertical direction Y will lead to a differential length among the slits forming the perforations. If the length of the component slit is not uniform, the film sheet 14 will be easily ripped along the slits which are relatively long but it will be difficult to rip the film sheet 14 along the slits which are relatively short.

It is possible for the apparatus according to the invention to obtain the slits each having the predetermined length and therefore even when the film sheet 14 folded into a plurality of layers must be formed with the perforations, the film sheet 14 can be prevented from being made difficult to be smoothly ripped along the perforations. Certainly there is a possibility that the individual perforating blades could not completely cut through the lower layers of the folded film sheet and, as a consequence, the lengths of the respective slits might be uneven. Such problem is solved, according to the present invention, by securely squeezing the folded film sheet 14 between the pressure plate 80 and the loading plate 100 and then using the individual blades 73 as have been described above to form the slits. In this way, the individual blades 73 reliably cut through the film sheet 14 including the lower layers thereof to length-equalize the individual slits formed thereby. Furthermore, the length dimension of the parallel lateral edges 76 may be shortened to reduce a dimension by which the loading plate 100 and the blade assembly holding plate 60 are apart from one another and thereby to downsize the apparatus.

The loading plate 100 is made of urethane and elastic at least in the vertical direction Y. When the film sheet 14 is pressed by the pressure plate 80 against the loading plate 100, the elasticity of the loading plate 100 cooperates with the elasticity of the rubber layer 82 to squeeze the film sheet 14 and securely hold it. The elasticity of the loading plate 100 in the vertical direction Y also serves to buffer an impact due to collision of the pressure plate 80 with the loading plate 100. While the loading plate 100 has the hardness Hs of 90 in the case of this particular embodiment, the hardness Hs is not limited to this value so far as the film sheet 14 is securely held without deformation of the slit 105 of the loading plate 100 due to a pressing force of the pressure plate 80. To ensure the film sheet 14 to be effectively squeezed and thereby to be securely held, it is obvious that a spring mounted on the upper side of the pressure plate 80 as the biasing means 90 must have a spring constant sufficient to prevent the film sheet 14 from being displaced. While the loading plate 100 itself functions as the anti-slip means according to this particular embodiment, it is possible to attach any separate anti-slip means to the loading plate 100.

While the individual blades 73 are arranged to describe a generally L-like shape so that the L-shape perforations would be formed according to the embodiment, the present invention is not limited to such arrangement. The present invention is applicable to any other arrangement of the individual blades 73. While rubber and urethane are used as the anti-slip means in the case of the illustrated embodiment, the present invention is not limited to them and any other appropriate material may be used so far as the selected material is able to squeeze and thereby to hold the film sheet and has a sufficiently high frictional force with respect to the film sheet to restrict slippage of the film sheet.

At least a range of the individual blades 73 extending from the pointed tip 74 to the parallel lateral edges 76 pass through the slit 105 of the loading plate 100 and thereby form the film sheet 14 with the slits each having the predetermined length. While the film sheet 14 is so-called gusset-folded into four layers to be formed with the perforations so far as the illustrated embodiment is concerned, at least two upper layers may be formed with the perforations. In other words, it is essential that any one corner of the package as shown in FIG. 2 can be ripped along the perforations. In order to form all of four layers with the slits at regular intervals, the perforating blade assembly 70 may be set so as to move further downward in the vertical direction Y. Specifically, for the film sheet 14 folded into a plurality of layers, the distance by which the perforating blade assembly 70 is movable downward in the vertical direction Y may be adjusted to determine the number of the layers to be formed with the slits along which the film sheet 14 can be ripped. Obviously, it is also possible to form a single film sheet 14 with the perforations.

1. An apparatus to form perforation comprising a loading plate on which a film sheet can be loaded, a perforating blade assembly adapted to form said film sheet with said perforations and a driving mechanism serving to move said perforating blade assembly up and down in a vertical direction so as to cut through said film sheet, said apparatus being characterized in that:
said apparatus further comprises a pressure plate opposed to said loading plate and adapted to press said film sheet against said loading plate;
said loading plate has a slit formed through said loading plate adapted to be engaged with said perforating blade assembly; and
said pressure plate is provided on its surface opposed to said film sheet with an anti-slip means.

2. The apparatus to form perforations according to claim 1, wherein:
said perforating blade assembly is held by a blade holding plate;
a biasing means is provided between said blade holding plate and said pressure plate to bias these blade holding plate and said pressure plate in said vertical direction; and
said holding plate is adapted to move said perforating blade assembly into said slit formed through said loading plate against a biasing effect of said biasing means.

3. The apparatus to form perforations according to claim 1, wherein a surface of said loading plate opposed to said film sheet is elastic at least in said vertical direction.

4. The apparatus to form perforations according to claim 1, wherein said loading plate is provided on its surface opposed to said film sheet with an anti-slip means.

5. The apparatus to form perforations according to claim 1, wherein said perforating blade assembly comprises a plurality of individual blades arranged in a line and each of said individual blades comprises a pointed tip facing said film sheet, a pair of oblique edges obliquely extending from said pointed tip in said vertical direction and a transverse direction orthogonal to said vertical direction wherein said oblique edges gradually draw apart one another in said transverse direction as they come upward in said vertical direction and a pair of parallel lateral edges extending upward from respective upper ends of said oblique edges in said vertical direction.

6. The apparatus to form perforations according to claim 5, wherein at least a range of said individual blade extending from said pointed tip to said parallel lateral edges is movable into said slit formed through said loading plate.

7. The apparatus to form perforations according to claim 5, wherein:
said pressure plate has a slit formed through said pressure plate in its thickness direction and having a substantially same shape as said slit formed through said loading plate; and
said individual blades are adapted to pass through said slit formed through said pressure plate and then to be engaged with said slit formed through said loading plate.

8. The apparatus to form perforations according to claim 1, wherein two or more layers of said film sheet are put flat together in a thickness direction thereof and loaded on said loading plate.
